(19) United States
(12) Patent Application Publication
(10) Pub. No.: US 2025/0105452 A1
(43) Pub. Date: Mar. 27, 2025

(54) ELECTRIC POWER STORAGE MODULE

(71) Applicants: KABUSHIKI KAISHA TOYOTA JIDOSHOKKI, Kariya-shi, Aichi (JP); TOYOTA JIDOSHA KABUSHIKI KAISHA, Toyota-shi, Aichi (JP)

(72) Inventors: Yuki OKAMOTO, Kariya-shi, Aichi (JP); Kodai SHINTANI, Toyota-shi, Aichi (JP)

(73) Assignees: KABUSHIKI KAISHA TOYOTA JIDOSHOKKI, Kariya-shi, Aichi (JP); TOYOTA JIDOSHA KABUSHIKI KAISHA, Toyota-cho (JP)

(21) Appl. No.: 18/729,952

(22) PCT Filed: Dec. 16, 2022
(86) PCT No.: PCT/JP2022/046455

§ 371 Date: Jul. 18, 2024

(30) Foreign Application Priority Data
Jan. 28, 2022 (JP) 2022-011644

(51) Int. Cl. H01M 50/46; H01M 4/02; H01M 10/0585; H01M 50/474; H01M 50/477; H01M 50/486; H01M 50/548

(52) U.S. Cl. CPC H01M 50/461; H01M 10/0585; H01M 50/474; H01M 50/477; H01M 50/486; H01M 50/548; H01M 2004/029

(57) ABSTRACT

An electric power storage module includes a stacked body having an outer surface, and a sheet member provided in close contact with the stacked body to cover the outer surface in a cross section in a stacking direction of the stacked body, wherein the stacked body includes a plurality of electrodes and a sealing part, the electrode includes a current collector having one surface and the other surface on a side opposite to the one surface, the plurality of electrodes are stacked so that the one surface of each of the current collectors faces the same direction, the sealing part defines a space which accommodates an electrolyte together with the current collector adjacent in the stacking direction, and the sheet member includes a metal layer, and a first insulating layer stacked on the metal layer.

### TECHNICAL FIELD

The present disclosure relates to an electric power storage module.

### BACKGROUND ART

Patent Literature 1 describes an assembled battery. This assembled battery is made by stacking a plurality of sheet-shaped polymer secondary batteries (unit cells) and connecting each of the unit cells in series. This assembled battery includes a metal upper exterior plate that also serves as a positive electrode current collector, a metal lower exterior plate that also serves as a negative electrode current collector, and a metal intermediate exterior plate that also serves as a positive and negative electrode current collector. A rectangular frame-shaped resin sealing body is provided between the upper exterior plate and the intermediate exterior plate and between the lower exterior plate and the intermediate exterior plate, respectively. The sealing body is heat welded to each of the exterior plates. A power generation element is disposed in a space surrounded by each of the exterior plates and the sealing body. The power generation element is configured of a positive electrode layer, a negative electrode layer, and a gel type electrolyte layer interposed between the positive electrode layer and the negative electrode layer. The gel type electrolyte layer includes a non-aqueous electrolyte solution and a polymer that holds the electrolyte solution.

### CITATION LIST

### Patent Document

[Patent Literature 1] Japanese Unexamined Patent Publication No. H11-233076

### SUMMARY OF INVENTION

### Technical Problem

However, in a non-aqueous secondary battery of which an electrolyte is a non-aqueous electrolyte, it is known that performance of the battery deteriorates due to moisture intrusion into the inside of the battery. Specifically, when moisture infiltrates into the battery, the quality of the electrolyte may change and resistance may increase, or an electrode active material or coating may decompose due to changed components, leading to a decrease in battery performance. Therefore, in the non-aqueous secondary battery, it is important to ensure airtightness of an exterior material of the battery in order to curb the intrusion of moisture such as atmospheric moisture. In the assembled battery described in Patent Literature 1, each of the power generation elements is sealed with a metal exterior plate and a resin frame-shaped sealing body. However, resins are known to be more permeable to moisture than metals. Therefore, sealing using a frame-shaped sealing body made of a resin may not be able to sufficiently curb moisture intrusion from the outside.

An object of the present disclosure is to provide an electric power storage module capable of curbing moisture intrusion while curbing short circuits.

### Solution to Problem

An electric power storage module according to the present disclosure includes a stacked body having an outer surface, and a sheet member provided in close contact with the stacked body to cover the outer surface in a cross section along a stacking direction of the stacked body, wherein the stacked body includes a plurality of electrodes and a sealing part, the electrode includes a current collector having one surface and the other surface on a side opposite to the one surface, the plurality of electrodes is stacked in the stacking direction so that the one surface of each of the current collectors faces the same direction, the sealing part defines a space accommodating an electrolyte together with the current collector adjacent in the stacking direction, the electrodes include a bipolar electrode, a positive terminal electrode, and a negative terminal electrode, the bipolar electrode includes a positive electrode active material layer provided on the one surface of the current collector, and a negative electrode active material layer provided on the other surface of the current collector, the positive terminal electrode has the positive electrode active material layer provided on the one surface of the current collector, the other surface of the current collector of the positive terminal electrode has an exposed portion exposed from the sealing part, the negative terminal electrode has the negative electrode active material layer provided on the other surface of the current collector, the one surface of the current collector of the negative terminal electrode has an exposed portion exposed from the sealing part, the sealing part includes a plurality of frame-shaped first resin layers provided on a peripheral edge portion of each of the plurality of current collectors, a plurality of frame-shaped spacers disposed to be interposed between the first resin layers adjacent in the stacking direction, and a second resin layer formed by welding end portions of each of the plurality of first resin layers and the plurality of spacers on a side opposite to the space when seen in the stacking direction, the outer surface includes a first surface, a second surface, and a third surface, the first surface is a surface of the first resin layer provided on the other surface of the current collector of the positive terminal electrode, which is on a side opposite to the current collector, the second surface is a surface of the first resin layer provided on the one surface of the current collector of the negative terminal electrode, which is on a side opposite to the current collector, the third surface is a surface of the second resin layer on a side opposite to the space and extends to connect the first surface and the second surface, the sheet member includes a metal layer, and a first insulating layer stacked on the metal layer and disposed closer to the outer surface than the metal layer, the sheet member extends from the first surface to the second surface through the third surface, a first end portion on the first surface of the sheet member and a second end portion on the second surface of the sheet member are located outside inner edges of the first resin layer and the spacer and inside an outer edge of the current collector when seen in the stacking direction, a first insulating member is provided from the first surface to the sheet member to cover the first end portion and is adhered to the first surface and the sheet member, and a second insulating member is provided from the second surface to the sheet member to cover the second end portion and is adhered to the second surface and the sheet member.

In the electric power storage module, in the stacked body including the plurality of bipolar electrodes, the positive terminal electrode, and the negative terminal electrode, the sealing part that defines a space that accommodates an electrolyte together with the current collector of each of the electrodes is provided. The sealing part includes the first resin layer provided on each of the current collectors, the spacer interposed between the first resin layers, and the second resin layer formed by welding the outer end portions of the first resin layer and the spacer to each other. The outer surface of the stacked body includes the first surface, the second surface, and the third surface. The first surface is the surface of the first resin layer provided on the other surface of the current collector of the positive terminal electrode, which is on the side opposite to the current collector. The second surface is the surface of the first resin layer provided on one side of the current collector of the negative terminal electrode, which is on the side opposite to the current collector. The third surface is the surface of the second resin layer on the side opposite to the space, and extends to connect the first surface and the second surface. The sheet member including a metal layer is provided in close contact with the stacked body to cover the outer surface of the stacked body. Since the metal layer included in the sheet member has high barrier properties against moisture, moisture intrusion is curbed compared to the case of only a resin layer. In particular, each of the first end portion and the second end portion of the sheet member is covered by the first insulating member and the second insulating member provided from the first surface and the second surface to the sheet member. Therefore, although the surfaces of the current collectors of the positive terminal electrode and the negative terminal electrode include exposed portions exposed from the sealing part, short circuits between the positive terminal electrode and the negative terminal electrode are curbed via this sheet member. In this way, according to the electric power storage module, when moisture intrusion is curbed, it is also possible to curb short circuits. The first end portion and the second end portion of the sheet member are located outside the inner edges of the first resin layer and the spacer and inside the outer edge of the current collector. That is, in addition to the first resin layer, the spacer is present directly below the portions on the first and second surfaces of the sheet member. Therefore, it is easy to apply pressure uniformly when the sheet member is brought into close contact with the first resin layer.

In the electric power storage module according to the present disclosure, each of the first insulating member and the second insulating member may be an insulating sheet including an adhesive layer adhered to each of the first surface and the second surface. In this case, a separate member for adhesion becomes unnecessary when the first insulating member and the second insulating member are adhered to the first resin layer.

In the electric power storage module according to the present disclosure, the insulating sheet may include a welding layer thermally welded to each of the first surface and the second surface as the adhesive layer. In this case, the first insulating member and the second insulating member can be adhered to the first resin layer by thermal welding.

In the electric power storage module according to the present disclosure, the welding layer may be further thermally welded to the sheet member. In this case, the first insulating member and the second insulating member can also be adhered to the sheet member by thermal welding.

In the electric power storage module according to the present disclosure, each of the first insulating member and the second insulating member may include a resin material hardened between the first surface and the second surface. In this case, a separate member for adhesion becomes unnecessary when the first insulating member and the second insulating member are adhered to the first resin layer.

In the electric power storage module according to the present disclosure, each of the first insulating member and the second insulating member may be adhered to each of the first surface and the second surface as well as the sheet member with an adhesive tape. In this case, each end portion of the sheet member can be reliably covered by the first resin member and the second resin member to curb short circuits.

### Advantageous Effects of Invention

According to the present disclosure, it is possible to provide an electric power storage module capable of curbing moisture intrusion while curbing short circuits.

### BRIEF DESCRIPTION OF DRAWINGS

FIG. 1 is a schematic cross-sectional view of an electric power storage module according to an embodiment.

FIG. 2 is a cross-sectional view showing a part of the electric power storage module shown in FIG. 1.

FIG. 3 is a schematic plan view of the electric power storage module shown in FIG. 1.

FIG. 4 is a schematic cross-sectional view showing various aspects of an insulating member shown in FIG. 1.

FIG. 5 is a schematic cross-sectional view showing another aspect of the insulating member shown in FIG. 1.

### DESCRIPTION OF EMBODIMENTS

Hereinafter, one embodiment of the present disclosure will be described in detail with reference to the accompanying drawings. In addition, in the description of the drawings, the same or equivalent elements may be designated by the same reference numerals, and redundant description may be omitted.

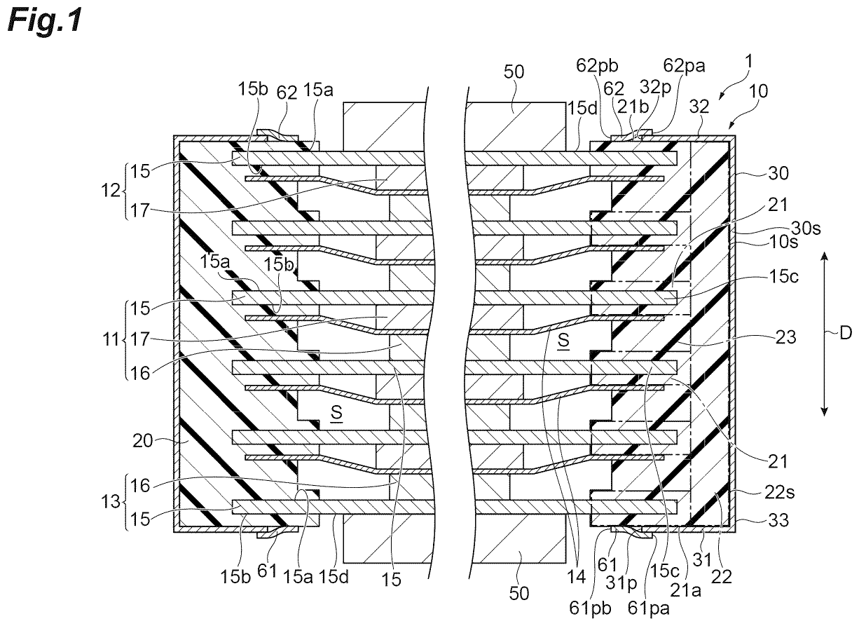

FIG. 1 is a schematic cross-sectional view of an electric power storage module according to this embodiment. The electric power storage module 1 shown in FIG. 1 is, for example, an electric power storage module used in batteries of various vehicles such as forklifts, hybrid vehicles, and electric vehicles. The electric power storage module 1 is, for example, a secondary battery such as a nickel-metal hydride secondary battery or a lithium ion secondary battery. The electric power storage module 1 may be an electric double layer capacitor or an all-solid-state battery. Here, a case in which the electric power storage module 1 is a lithium ion secondary battery will be exemplified.

The electric power storage module 1 includes a stacked body 10 and a sheet member 30. The stacked body 10 includes a plurality of electrodes, a plurality of separators 14, a sealing part 20, and an electrolyte (not shown). The plurality of electrodes include a plurality of bipolar electrodes 11, a negative terminal electrode 12, and a positive terminal electrode 13.

Each of the plurality of bipolar electrodes 11 includes a current collector 15, a positive electrode active material layer 16, and a negative electrode active material layer 17. The current collector 15 has a rectangular sheet shape, for example. The positive electrode active material layer 16 is provided on one surface 15a of the current collector 15. The negative electrode active material layer 17 is provided on the other surface 15b of the current collector 15. The plurality of bipolar electrodes 11 are stacked such that the positive electrode active material layer 16 of one bipolar electrode 11 and the negative electrode active material layer 17 of another bipolar electrode 11 face each other. Here, a direction in which the bipolar electrodes 11 are stacked is referred to as a stacking direction D. The one surface 15a of the current collector 15 is a surface that faces one side in the stacking direction D, and the other surface 15b of the current collector 15 is a surface (a surface on the side opposite to the one surface 15a) that faces the other side in the stacking direction D.

The positive electrode active material layer 16 and the negative electrode active material layer 17 have a rectangular shape when seen in the stacking direction D. The negative electrode active material layer 17 is one size larger than the positive electrode active material layer 16 when seen in the stacking direction D. That is, in a plan view seen in the stacking direction D, an entire formation region of the positive electrode active material layer 16 is located within a formation region of the negative electrode active material layer 17.

The negative terminal electrode 12 includes the current collector 15 and the negative electrode active material layer 17 provided on the other surface 15b of the current collector 15. The negative terminal electrode 12 does not include the positive electrode active material layer 16 and the negative electrode active material layer 17 on one surface 15a of the current collector 15. That is, no electrode active material layer is provided on the one surface 15a of the current collector 15 of the negative terminal electrode 12. The negative terminal electrode 12 is stacked on the bipolar electrode 11 at one end portion of the stacked body 10 in the stacking direction D. The negative terminal electrode 12 is stacked on the bipolar electrode 11 such that the negative electrode active material layer 17 thereof faces the positive electrode active material layer 16 of the bipolar electrode 11. Therefore, the one surface 15a of the current collector 15 of the negative terminal electrode 12 faces the outside of the stacked body 10, and a part thereof is exposed to the outside of the stacked body 10.

The positive terminal electrode 13 includes the current collector 15 and the positive electrode active material layer 16 provided on the one surface 15a of the current collector 15. The positive terminal electrode 13 does not include the positive electrode active material layer 16 and the negative electrode active material layer 17 on the other surface 15b of the current collector 15. In other words, no electrode active material layer is provided on the other surface 15b of the current collector 15 of the positive terminal electrode 13. The positive terminal electrode 13 is stacked on the bipolar electrode 11 at the other end portion of the stacked body 10 in the stacking direction D. The positive terminal electrode 13 is stacked on the bipolar electrode 11 such that the positive electrode active material layer 16 thereof faces the negative electrode active material layer 17 of the bipolar electrode 11.

Therefore, the other surface 15b of the current collector 15 of the positive terminal electrode 13 faces the outside of the stacked body 10, and a part thereof is exposed to the outside of the stacked body 10.

As described above, the stacked body 10 includes a plurality of electrodes. Each of the plurality of electrodes includes the current collector 15 having the one surface 15a and the other surface 15b in the stacking direction D, and at least one of the positive electrode active material layer 16 and the negative electrode active material layer 17. The plurality of electrodes are stacked such that the respective current collectors 15 are stacked in the stacking direction D so that the one surfaces 15a (or the other surface 15b) face the same direction.

The separator 14 is disposed between adjacent bipolar electrodes 11, between the negative terminal electrode 12 and the bipolar electrode 11, and between the positive terminal electrode 13 and the bipolar electrode 11. The separator 14 is interposed between the positive electrode active material layer 16 and the negative electrode active material layer 17. The separator 14 separates the positive electrode active material layer 16 and the negative electrode active material layer 17 to prevent short circuits caused by contact between adjacent electrodes. The separator 14 allows charge carriers such as lithium ions to pass through.

The current collector 15 is a chemically inert electrical conductor that allows a current to continue flowing through the positive electrode active material layer 16 and the negative electrode active material layer 17 during discharging or charging of the lithium ion secondary battery. A material of the current collector 15 is, for example, a metal material, a conductive resin material, a conductive inorganic material, or the like. Examples of the conductive resin material include resins in which a conductive filler is added to a conductive polymer material or a non-conductive polymer material as necessary. The current collector 15 may include a plurality of layers. In this case, each of the layers of the current collector 15 may contain the above metal material or conductive resin material.

A coating layer may be formed on a surface of the current collector 15. The coating layer may be formed by a known method such as plating or spray coating. The current collector 15 may have, for example, a plate shape, a foil shape (for example, a metal foil), a film shape, a mesh shape, or the like. Examples of the metal foil include an aluminum foil, a copper foil, a nickel foil, a titanium foil, and a stainless steel foil. Examples of the stainless steel foil include SUS 304, SUS 316, SUS 301, or the like defined in JIS G 4305:2015. When the stainless steel foil is used as the current collector 15, mechanical strength of the current collector 15 can be ensured. The current collector 15 may be an alloy foil or clad foil of the above metal. When the current collector 15 has a foil shape, a thickness of the current collector 15 may be, for example, 1 μm to 100 μm.

The positive electrode active material layer 16 includes a positive electrode active material that can occlude and release charge carriers such as lithium ions. Examples of the positive electrode active material include lithium composite metal oxides having a layered rock salt structure, metal oxides having a spinel structure, and polyanionic compounds. The positive electrode active material may be any material that can be used in lithium ion secondary batteries. The positive electrode active material layer 16 may include a plurality of positive electrode active materials. In this embodiment, the positive electrode active material layer 16 contains olivine-type lithium iron phosphate (LiFePO₄) as a composite oxide.

The negative electrode active material layer 17 includes a negative electrode active material that can occlude and release charge carriers such as lithium ions. The negative electrode active material may be any one of a single element, an alloy, and a compound. Examples of the negative electrode active material include Li, carbon, metal compounds, and the like. The negative electrode active material may be an element that can be alloyed with lithium, a compound thereof, or the like. Examples of carbon include natural graphite, artificial graphite, hard carbon (hardly graphitizable carbon), and soft carbon (easily graphitizable carbon). Examples of the artificial graphite include highly oriented graphite, mesocarbon microbeads, and the like. Examples of elements that can be alloyed with lithium include silicon, tin, and the like. In this embodiment, the negative electrode active material layer 17 contains graphite as a carbon-based material.

Each of the positive electrode active material layer 16 and the negative electrode active material layer 17 (hereinafter, it may be simply referred to as “electrode active material layer”) may further include a conductive assistant, a binder, an electrolyte (a polymer matrix, an ionically conductive polymer, an electrolyte solution, or the like), an electrolyte supporting salt (lithium salt) to increase ionic conductivity, and the like for increasing electrical conductivity, if necessary. The conductive assistant is added to enhance conductivity of each of the electrodes (the bipolar electrode 11, the negative terminal electrode 12, the positive terminal electrode 13). Examples of the conductive assistant include acetylene black, carbon black, graphite, and the like.

Examples of the binder include polyvinylidene fluoride, polytetrafluoroethylene, fluororesins such as fluororubber, thermoplastic resins such as polypropylene and polyethylene, imide-based resins such as polyimide and polyamideimide, alkoxysilyl group-containing resins, acrylic resins such as acrylic acid or methacrylic acid, styrene-butadiene rubber (SBR), carboxymethyl cellulose, alginates such as sodium alginate and ammonium alginate, water-soluble crosslinked cellulose esters, starch-acrylic acid graft polymers, and the like. The binders may be used alone or in combination. As a solvent of the binder, for example, water, N-methyl-2-pyrrolidone (NMP), or the like are used.

The separator 14 may be, for example, a porous sheet or nonwoven fabric containing a polymer that absorbs and holds an electrolyte. Examples of the material for the separator 14 include polypropylene, polyethylene, polyolefin, polyester, and the like. The separator 14 may have a single layer structure or a multilayer structure. The multilayer structure may have, for example, a ceramic layer as an adhesive layer or a heat-resistant layer. The separator 14 may be impregnated with an electrolyte. The separator 14 may be made of an electrolyte such as a polymer electrolyte or an inorganic electrolyte. The electrolyte impregnated into the separator 14 may include, for example, a liquid electrolyte (an electrolyte solution) containing a non-aqueous solvent and an electrolyte salt dissolved in the non-aqueous solvent, or a polymer gel electrolyte containing an electrolyte held in a polymer matrix.

When the separator 14 is impregnated with an electrolytic solution, known lithium salts such as LiClO₄, LiAsF₆, LiPF₆, LiBF₄, LiCF₃SO₃, LiN(FSO₂)₂, and LiN(CF₃SO₂)₂ may be used as the electrolyte salt. Further, as the non-aqueous solvent, known solvents such as cyclic carbonates, cyclic esters, chain carbonates, chain esters, and ethers may be used. Two or more of the known solvent materials may be used in combination.

The sealing part 20 is formed in a frame shape at a peripheral edge portion of the stacked body 10 to surround the stacked body 10. The sealing part 20 can be joined to each of the one surface 15a and the other surface 15b of each of the current collectors 15 at a peripheral edge portion 15c of each of the current collectors 15. The sealing part 20 seals each of spaces S between adjacent current collectors 15 in the stacking direction D. Each of the spaces S accommodates an electrolyte. That is, the sealing part 20 defines a space S that accommodates the electrolyte together with the current collector 15 adjacent in the stacking direction D. When the electrolyte is liquid, the sealing part 20 prevents the electrolyte from permeating to the outside.

The sealing part 20 curbs moisture and the like entering the space S from the outside of the stacked body 10. The sealing part 20 prevents, for example, gas generated at each of the electrodes due to a charging and discharging reaction or the like from leaking to the outside of the electric power storage module 1. An edge portion of each of the separators 14 is joined to the sealing part 20. The sealing part 20 includes an insulating material. Examples of the material of the sealing part 20 include various resin materials such as polypropylene, polyethylene, polystyrene, ABS resins, acid-modified polypropylene, acid-modified polyethylene, and acrylonitrile styrene resins.

The sealing part 20 includes a plurality of first resin layers 21, a second resin layer 22, and a plurality of spacers 23. The first resin layer 21 is provided on each of the current collectors 15. Therefore, the plurality of first resin layers 21 are stacked on each other in the stacking direction D. The first resin layer 21 has a frame shape, and is provided on the peripheral edge portion 15c of the current collector 15. That is, the first resin layer 21 is provided from the one surface 15a of the current collector 15 to the other surface 15b via an end surface, and covers the peripheral edge portion 15c. The first resin layer 21 may be welded to at least one of the one surface 15a and the other surface 15b of the current collector 15.

Each of the plurality of spacers 23 is disposed to be interposed between the adjacent first resin layers 21 in the stacking direction D. Thus, each of the spacers 23 holds a space between adjacent first resin layers 21, that is, between adjacent current collectors 15. The spacer 23 has a frame shape, and is disposed on the peripheral edge portion 15c of the current collector 15 when seen in the stacking direction D. The spacer 23 may be welded to at least one of a pair of first resin layers 21 adjacent to each other in the stacking direction D. Here, an end portion of the separator 14 is sandwiched and fixed between the first resin layer 21 and the spacer 23.

The second resin layer 22 is an end surface welding layer formed by welding and integrating portions of the plurality of first resin layers 21 and the plurality of spacers 23 that overlap in the stacking direction D. That is, the second resin layer 22 is formed by welding end portions of the plurality of first resin layers 21 and the plurality of spacers 23 on the side opposite to the space S when seen in the stacking direction D. The second resin layer 22 has a frame shape surrounding the stacked body 10 when seen in the stacking direction D. In the second resin layer 22, end portions of the plurality of first resin layers 21 and end portions of the plurality of spacers 23 adjacent to each other are welded and integrated, and thus, the space S formed between adjacent electrodes with the separator 14 interposed therebetween is sealed. An end surface of the second resin layer 22 on the side opposite to the space S constitutes a part of an outer surface 10s of the stacked body 10.

That is, the outer surface 10s of the stacked body 10 includes a first surface 21a, a second surface 21b, and a third surface 22s. The first surface 21a is an outer surface in the stacking direction D of the first resin layer 21 provided on the current collector 15 of the positive terminal electrode 13. The second surface 21b is an outer surface in the stacking direction D of the first resin layer 21 provided on the current collector 15 of the negative terminal electrode 12. The third surface 22s is an end surface of the second resin layer 22 on the side opposite to the space S. In other words, the outer surface 10s of the stacked body 10 includes the first surface 21a that is a surface of the first resin layer 21, which is provided on the other surface 15b of the current collector 15 of the positive terminal electrode 13, on the side opposite to the current collector 15, the second surface 21b that is a surface of the first resin layer 21, which is provided on the one surface 15a of the current collector 15 of the negative terminal electrode 12, on the side opposite to the current collector 15, and the third surface 22s that is a surface (an end surface) of the second resin layer 22 on the side opposite to the space S and extends to connect the first surface 21a and the second surface 21b. That is, the outer surface 10s of the stacked body 10 here is an outer surface of the sealing part 20.

The one surface 15a of the negative terminal electrode 12 that faces the outside of the stacked body 10 includes an exposed portion 15d exposed to the outside from the sealing part 20 (the first resin layer 21). The exposed portion 15d of the negative terminal electrode 12 is a portion of the current collector 15 of the negative terminal electrode 12 other than the second surface 21b (a portion that does not overlap the second surface 21b) when seen in the stacking direction D. Further, the other surface 15b of the positive terminal electrode 13 that faces the outside of the stacked body 10 includes an exposed portion 15d exposed to the outside from the sealing part 20 (the first resin layer 21). The exposed portion 15d of the positive terminal electrode 13 is a portion of the current collector 15 of the positive terminal electrode 13 other than the first surface 21a (a portion that does not overlap the first surface 21a) when seen in the stacking direction D.

The exposed portions 15d provided at the negative terminal electrode 12 and the positive terminal electrode 13 function as terminals for extracting current from the electric power storage module 1. In the electric power storage module 1, a conductive member 50 is disposed on the exposed portions 15d and electrically connected. The conductive member 50 is used to electrically connect a plurality of electric power storage modules 1. Furthermore, the conductive member 50 can also be used as a restriction member to apply a restriction load to the stacked body 10.

A cooling channel may be formed in the conductive member 50. The stacked body 10 can be cooled by flowing a cooling medium through the cooling channel formed in the conductive member 50. In other words, coolers are disposed at both end portions of the stacked body 10 in the stacking direction D with respect to the exposed portion 15d of the outer surface of the current collector 15. In this case, dew condensation water is more likely to generate around the conductive member 50 at both end portions of the stacked body 10 in the stacking direction D compared to other portions.

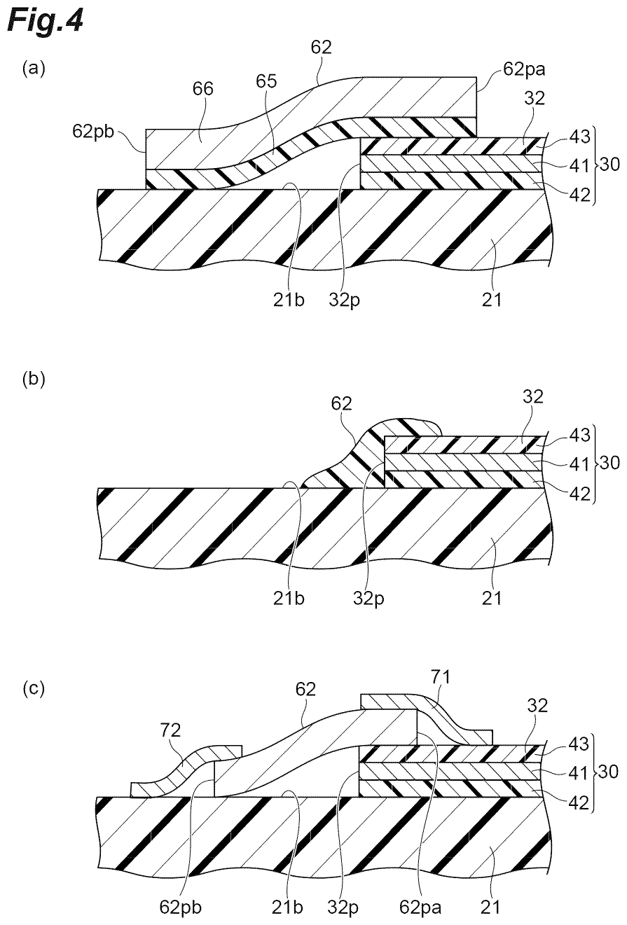

The sheet member 30 is disposed in close contact with the stacked body 10 to cover the outer surface 10s of the stacked body 10. The sheet member 30 includes at least a metal layer 41 and a first insulating layer 42 stacked on the metal layer 41. In this embodiment, the sheet member 30 further includes a second insulating layer 43 stacked on the metal layer 41 on the side opposite to the first insulating layer 42 (refer to FIG. 4). The second insulating layer 43 is provided on the other surface of the metal layer 41 opposite to one surface on which the first insulating layer 42 is provided. That is, the sheet member 30 is configured by sandwiching the metal layer 41 between the first insulating layer 42 and the second insulating layer 43. The sheet member 30 is provided on the stacked body 10 so that the first insulating layer 42 is on the outer surface 10s side of the stacked body 10. Here, the first insulating layer 42 is in contact with the outer surface 10s. In the sheet member 30, the first insulating layer 42 may function as an adhesive layer to the outer surface 10s, or another adhesive layer may be interposed therebetween.

The first insulating layer 42 is made of a resin having insulating properties. A material of the first insulating layer 42 is, for example, polypropylene, polyethylene, polyamide, or the like. The material of the first insulating layer 42 may be selected from the same materials as the sealing part 20 from the viewpoint of adhesiveness with the sealing part 20. The metal layer 41 is made of a material with low moisture permeability (a low moisture permeability coefficient), such as an aluminum foil or a stainless steel foil. The second insulating layer 43 is made of, for example, a resin having insulating properties. The material of the second insulating layer 43 is, for example, polypropylene, polyethylene, polyamide, nylon, or the like. As an example, the sheet member 30 is an aluminum laminate sheet, and polypropylene may be selected as the first insulating layer 42, aluminum may be selected as the metal layer 41, and polyethylene terephthalate may be selected as the second insulating layer 43.

The sheet member 30 includes a first portion 31, a second portion 32, and a third portion 33. The first portion 31 is located on the first surface 21a on the positive terminal electrode 13 side. The second portion 32 is located on the second surface 21b on the negative terminal electrode 12 side. The third portion 33 is located on the third surface 22s. Here, the first portion 31, the second portion 32, and the third portion 33 are provided integrally and continuously with each other. Thus, the sheet member 30 extends from the first surface 21a to the second surface 21b via the third surface 22s. The sheet member 30 may be divided into a plurality of portions that are insulated from each other.

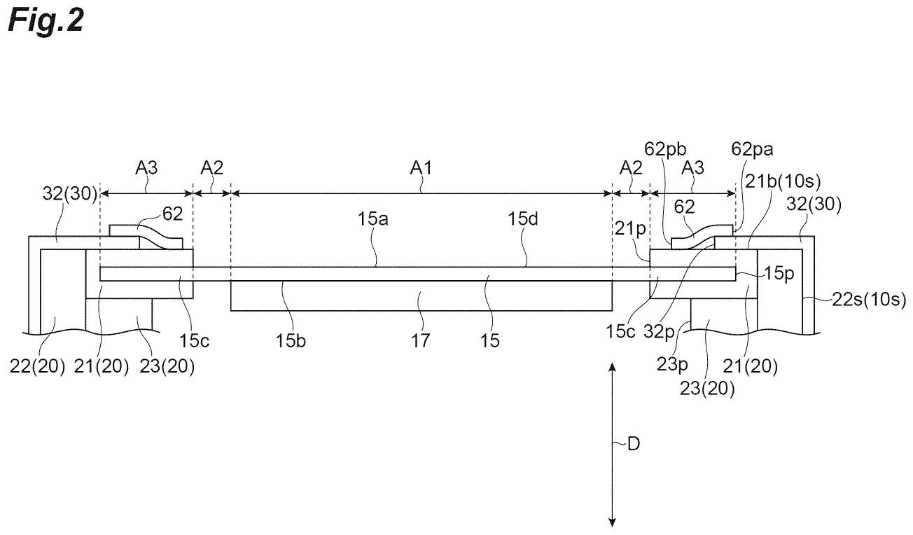

As shown in FIG. 2, the current collector 15 of the negative terminal electrode 12 includes a first region A1, a second region A2, and a third region A3 when seen in the stacking direction D. The first region A1 is a region in which the negative electrode active material layer 17 is formed when seen in the stacking direction D. The second region A2 is located outside the first region A1 when seen in the stacking direction D, and is a region in which the negative electrode active material layer 17 is not formed. The third region A3 is located outside the second region A2 when seen in the stacking direction D, and is a region in which the first resin layer 21 is formed. Similarly, the current collector 15 of the positive terminal electrode 13 includes a first region A1, a second region A2, and a third region A3 when seen in the stacking direction D. The first region A1 is a region in which the positive electrode active material layer 16 is formed when seen in the stacking direction D. The second region A2 is located outside the first region A1 when seen in the stacking direction D, and is a region in which the positive electrode active material layer 16 is not formed. The third region A3 is located outside the second region A2 when seen in the stacking direction D, and is a region in which the first resin layer 21 is formed. As an example, the sheet member 30 extends to overlap a part of the third region A3 of the current collector 15 on the side opposite to a boundary with the second region A2, when seen in the stacking direction D.

On the other hand, the sheet member 30 may be terminated not to reach the exposed portion 15d including the first region A1 and the second region A2. Therefore, a second end portion 32p (of the second portion 32) on the second surface 21b of the sheet member 30 and a first end portion 31p (of the first portion 31) on the first surface 21a of the sheet member 30 (refer to FIG. 1) may be disposed on the third region A3. Here, the first end portion 31p and the second end portion 32p are located outside an inner edge 23p of the spacer 23 and inside an outer edge 15p of the current collector 15, when seen in the stacking direction D. FIG. 2 is a cross-sectional view showing a part of the electric power storage module shown in FIG. 1, but hatching is omitted.

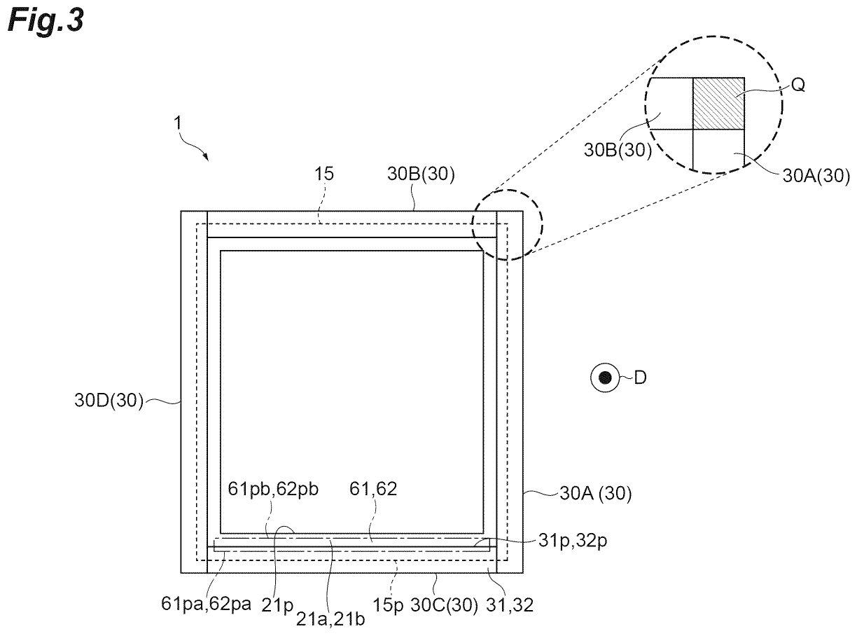

As shown in FIG. 3, the stacked body 10 (the outer surface 10s) has a polygonal shape having a plurality of sides when seen in the stacking direction D. Here, the stacked body 10 has a rectangular shape having four sides when seen in the stacking direction D. The sheet member 30 is configured of four portions 30A, 30B, 30C, and 30D along each of the four side portions when seen in the stacking direction D. In other words, the sheet member 30 is configured of the four portions 30A to 30D that cover each of the four side surfaces of the outer surface 10s having a square tubular shape. When seen in the stacking direction D, in a corner portion including a portion at which two side surfaces of the outer surface 10s intersect, for example, the sheet members 30 (for example, the portion 30A and the portion 30B) provided on the two side portions overlap each other to form an overlapping portion Q. Thus, formation of a conductive path due to dew condensation water entering between the portions is curbed.

Here, as shown in FIGS. 1 to 3 and FIG. 4A, the electric power storage module 1 includes a first insulating member 61 and a second insulating member 62. The first insulating member 61 is provided at the first end portion 31p on the first surface 21a of the sheet member 30. The second insulating member 62 is provided at the second end portion 32p on the second surface 21b of the sheet member 30. The first insulating member 61 is provided from the first surface 21a to the sheet member 30 to cover the first end portion 31p, and is adhered to the first surface 21a and the sheet member 30. The first insulating member 61 is disposed on the sheet member 30 (on the outside of the sheet member 30 in the stacking direction D) and is adhered to the second insulating layer 43 of the sheet member 30. When seen in the stacking direction D, a first end portion 61pa (an outer edge) of the first insulating member 61 is located outside the first end portion 31p (an inner edge) of the first portion 31 of the sheet member 30. A second end portion 61pb (an inner edge) of the first insulating member 61 on the side opposite to the first end portion 61pa is located outside an inner edge 21p of the first resin layer 21. Therefore, here, the entire first insulating member 61 is located on the first resin layer 21 and the sheet member 30.

The second insulating member 62 is provided from the second surface 21b to the sheet member 30 to cover the second end portion 32p, and is adhered to the second surface 21b and the sheet member 30. The second insulating member 62 is disposed on the sheet member 30 (outside the sheet member 30 in the stacking direction D) and is adhered to the second insulating layer 43 of the sheet member 30. Here, the second insulating member 62 is an insulating sheet that includes an adhesive layer 65 adhered to the second surface 21b and the sheet member 30 (the second insulating layer 43), and another layer 66 stacked on the adhesive layer 65. The other layer 66 may have a multilayer structure that further includes a metal layer and the like. The adhesive layer 65 may be, for example, a welding layer thermally welded to the second surface 21b and the sheet member 30 (the second insulating layer 43). The first insulating member 61 may also have the same configuration as the second insulating member 62. That is, the first insulating member 61 may also be an insulating sheet that includes an adhesive layer 65 (a welding layer) adhered to the first surface 21a and the sheet member 30 (the second insulating layer 43), and another layer 66 stacked on the adhesive layer 65.

When seen in the stacking direction D, a first end portion 62pa (an outer edge) of the second insulating member 62 is located outside the second end portion 32p (the inner edge) of the second portion 32 of the sheet member 30. A second end portion 62pb (an inner edge) of the second insulating member 62 on the side opposite to the first end portion 62pa is located outside the inner edge 21p of the first resin layer 21. Therefore, here, the entire second insulating member 62 is located on the first resin layer 21 and the sheet member 30. The first insulating member 61 and the second insulating member 62 may be configured of any material that can ensure electrical insulation. When the first insulating member 61 and the second insulating member 62 are insulating sheets, an example of the material of the insulating layer is a resin material such as polypropylene, polyethylene, polyamide, or polyethylene terephthalate.

As an example, although FIG. 3 shows a state in which the first insulating member 61 and the second insulating member 62 are provided for a portion 30C of the sheet member 30 along one side of the stacked body 10 when seen in the stacking direction D, the first insulating member 61 and the second insulating member 62 may be provided for all portions 30A to 30D of the sheet member 30.

As described above, in the electric power storage module 1, the sealing part 20 which defines the space S accommodating an electrolyte together with the current collector 15 of each of the electrodes is provided in the stacked body 10 including the plurality of bipolar electrodes 11, the positive terminal electrode 13, and the negative terminal electrode 12. The sealing part 20 includes the first resin layer 21 provided on each of the current collectors 15, the spacer 23 interposed between the first resin layers 21, and the second resin layer 22 formed by welding the outer end portions of the first resin layer 21 and the spacer 23 to each other. The outer surface 10s of the stacked body 10 includes the first surface 21a, the second surface 21b, and the third surface 22c. The first surface 21a is a surface of the first resin layer 21 provided on the other surface 15b of the current collector 15 of the positive terminal electrode 13, which is opposite to the other surface 15b. The second surface 21b is a surface of the first resin layer 21 provided on the one surface 15a of the current collector 15 of the negative terminal electrode 12, which is opposite to the one surface 15a. The third surface 22s is a surface of the second resin layer 22 on the side opposite to the space S, and extends to connect the first surface 21a and the second surface 21b. The sheet member 30 including the metal layer 41 is provided to cover the outer surface 10s of the stacked body 10 in close contact therewith.

Since the metal layer 41 included in the sheet member 30 has high barrier properties against moisture, moisture intrusion is curbed compared to the case of only a resin layer. In particular, each of the first end portion 31p on the first surface 21a and the second end portion 32p on the second surface 21b of the sheet member 30 is covered with the first insulating member 61 and the second insulating member 62 which are respectively provided from the first surface 21a and the second surface 21b to the sheet member 30. Therefore, although the outer surfaces of the current collectors 15 of the positive terminal electrode 13 and the negative terminal electrode 12 include the exposed portion 15d exposed from the sealing part 20, short-circuits between the positive terminal electrode 13 and the negative terminal electrode 12 are curbed via this sheet member 30.

In this way, according to the electric power storage module 1, when moisture intrusion is curbed, it is also possible to curb short circuits. The first end portion 31p and the second end portion 32p of the sheet member 30 are located outside the inner edge 21p of the first resin layer 21 and the inner edge 23p of the spacer 23 and inside the outer edge 15p of the current collector 15. That is, in addition to the first resin layer 21, the spacer 23 is present directly below the portions of the sheet member 30 on the first surface 21a and the second surface 21b. Therefore, it is easy to apply pressure uniformly when the sheet member 30 is brought into close contact with the first resin layer 21.

Furthermore, in the electric power storage module 1, the sheet member 30 includes the second insulating layer 43 stacked on the metal layer 41 on the side opposite to the first insulating layer 42. The first insulating member 61 and the second insulating member 62 overlap and are adhered to the second insulating layer 43 of the sheet member 30. Thus, insulation can be easily and reliably ensured.

Furthermore, in the electric power storage module 1, the stacked body 10 has a rectangular shape having four side portions when seen in the stacking direction D, and the sheet member 30 is configured of the four portions 30A to 30D along each of the four side portions when seen in the stacking direction D. Therefore, the sheet member 30 can be easily constructed by preparing the plurality of portions 30A to 30D corresponding to each of the side portions of the stacked body 10 when seen in the stacking direction D.

The above embodiment describes one aspect of the electric power storage module according to the present disclosure. The electric power storage module according to the present disclosure may be an arbitrary modification of the electric power storage module 1 described above. Subsequently, modified examples will be described.

For example, in the above embodiment, as shown in FIG. 4A, the example in which the first insulating member 61 and the second insulating member 62 are formed in a sheet shape and are adhered to the first surface 21a and the second surface 21b or the sheet member 30 by the adhesive layer 65 thereof has been described. However, the aspects of the first insulating member 61 and the second insulating member 62 are not limited thereto.

As shown in FIG. 4B, the second insulating member 62 may include a resin material hardened between the second surface 21b of the first resin layer 21 and the sheet member 30. Similarly, the first insulating member 61 may also include a resin material hardened between the first surface 21a of the first resin layer 21 and the sheet member 30. In this case, the first insulating member 61 and the second insulating member 62 may be constructed by arranging a fluid resin material such as a liquid over the first resin layer 21 and the sheet member 30 and hardening the resin material with heat, water, or the like. As the material in this case, any material that can be hardened by heat, water, or the like can be used, for example, liquid silicone or rust-proof seal.

Further, as shown in FIG. 4C, the second insulating member 62 is a resin sheet that itself does not have an adhesive layer (it may have an adhesive layer), and may be adhered to the second surface 21b of the first resin layer 21 and the sheet member 30 with adhesive tapes 71 and 72. Here, the second insulating member 62 is disposed from the second surface 21b to the sheet member 30 to cover the second end portion 32p of the sheet member 30. The first end portion 62pa of the second insulating member 62 is adhered to the sheet member 30 with an adhesive tape 71, and the second end portion 62pb of the second insulating member 62 is adhered to the second surface 21b with an adhesive tape 72. Similarly, the first insulating member 61 is a resin sheet that itself does not have an adhesive layer (it may have an adhesive layer), and may be adhered to the first surface 21a of the first resin layer 21 and the sheet member 30 with adhesive tapes 71 and 72. The adhesive tapes 71 and 72 are, for example, Kapton tapes.

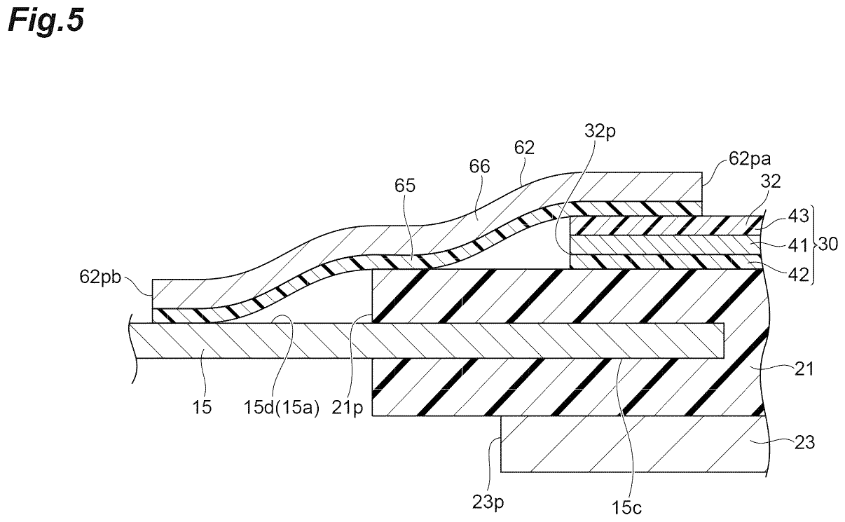

Further, as shown in FIG. 5, the second insulating member 62 may not be terminated on the second surface 21b of the first resin layer 21, and may extend to reach the exposed portion 15d of the current collector 15. Here, the second insulating member 62 is provided to extend from the exposed portion 15d of the current collector 15 to the sheet member 30 via the second surface 21b of the first resin layer 21. In this case, the second insulating member 62 may be further adhered to the current collector 15 in addition to the second surface 21b and the sheet member 30. Further, in this case, the second end portion 62pb of the second insulating member 62 may extend to the vicinity of the outer edge of the negative electrode active material layer 17 when seen in the stacking direction D. That is, the second end portion 62pb may be disposed near a boundary between the first region A1 and the second region A2. However, the second insulating member 62 may be configured not to overlap the negative electrode active material layer 17 when seen in the stacking direction D.

Similarly, the first insulating member 61 may not be terminated on the first surface 21a of the first resin layer 21, and may extend to reach the exposed portion 15d of the current collector 15. That is, the first insulating member 61 may also be provided to extend from the exposed portion 15d of the current collector 15 to the sheet member 30 through the first surface 21a of the first resin layer 21. In this case, the second end portion 61pb of the first insulating member 61 may also be disposed near the boundary between the first region A1 and the second region A2 not to overlap the positive electrode active material layer 16 when seen in the stacking direction D.

As described above, various aspects may be adopted for the first insulating member 61 and the second insulating member 62. At this time, it is not essential that the first insulating member 61 and the second insulating member 62 have the same aspect, and they may have different aspects.

Furthermore, in the above example, although the case in which the sheet member 30 has three layers including the first insulating layer 42, the metal layer 41, and the second insulating layer 43 has been described, from the viewpoint of curbing short circuits and moisture intrusion, the sheet member 30 only needs to have at least the metal layer 41 and the first insulating layer 42. Alternatively, the sheet member 30 may have four or more layers including the metal layer 41 and the first insulating layer 42.

Furthermore, in the above example, the sheet member 30 is provided along each of the four side portions of the stacked body 10 when seen in the stacking direction D. However, in the electric power storage module 1, the sheet member 30 only needs to be provided along at least one of the four side portions of the stacked body 10 when seen in the stacking direction D. That is, the sheet member 30 is not limited to the case in which it is configured of four portions 30A to 30D that cover each of the four side surfaces of the square tubular outer surface 10s, and from the viewpoint of curbing short circuits and moisture intrusion, it is sufficient to have a portion that covers at least one side surface.

The first insulating member 61 and the second insulating member 62 only need to cover each of the first end portion 31p and second end portion 32p of the sheet member 30 (that is, both end surfaces of the sheet member 30 in the cross section in the stacking direction D), and in particular, only needs to cover the end surface of the metal layer 41 in the cross section in the stacking direction D.

### Industrial Applicability

An electric power storage module is provided that can curb moisture intrusion while short circuit is curbed.

### Reference Signs List

1 Electric power storage module, 10 Stacked body, 10s Outer surface, 11 Bipolar electrode, 12 Negative terminal electrode, 13 Positive terminal electrode, 15 Current collector, 15c Peripheral edge portion, 15d Exposed portion, 16 Positive electrode active material layer, 17 Negative electrode active material layer, 20 Sealing part, 21 First resin layer, 21a First surface, 21b Second surface, 22 Second resin layer, 22s Third surface, 23 Spacer, 30 Sheet member, 31 First portion, 32 Second portion, 33 Third portion, 41 Metal layer, 42 First insulating layer, 43 Second insulating layer, 61 First insulating member, 62 Second insulating member, 65 Adhesive layer (welding layer), 71, 72 Adhesive tape

1. An electric power storage module comprising:
a stacked body having an outer surface; and
a sheet member provided in close contact with the stacked body to cover the outer surface in a cross section along a stacking direction of the stacked body,
wherein the stacked body includes a plurality of electrodes and a sealing part,
the electrode includes a current collector having one surface and the other surface on a side opposite to the one surface,
the plurality of electrodes is stacked in the stacking direction so that the one surface of each of the current collectors faces the same direction,
the sealing part defines a space accommodating an electrolyte together with the current collector adjacent along the stacking direction,
the electrodes include a bipolar electrode, a positive terminal electrode, and a negative terminal electrode,
the bipolar electrode includes a positive electrode active material layer provided on the one surface of the current collector, and a negative electrode active material layer provided on the other surface of the current collector,
the positive terminal electrode has the positive electrode active material layer provided on the one surface of the current collector,
the other surface of the current collector of the positive terminal electrode has an exposed portion exposed from the sealing part,
the negative terminal electrode has the negative electrode active material layer provided on the other surface of the current collector,
the one surface of the current collector of the negative terminal electrode has an exposed portion exposed from the sealing part,
the sealing part includes a plurality of frame-shaped first resin layers provided on a peripheral edge portion of each of the plurality of current collectors, a plurality of frame-shaped spacers disposed to be interposed between the first resin layers adjacent in the stacking direction, and a second resin layer formed by welding end portions of each of the plurality of first resin layers and the plurality of spacers on a side opposite to the space when seen in the stacking direction,
the outer surface includes a first surface, a second surface, and a third surface,
the first surface is a surface of the first resin layer provided on the other surface of the current collector of the positive terminal electrode, which is on a side opposite to the current collector,
the second surface is a surface of the first resin layer provided on the one surface of the current collector of the negative terminal electrode, which is on a side opposite to the current collector,
the third surface is a surface of the second resin layer on a side opposite to the space and extends to connect the first surface and the second surface,
the sheet member includes a metal layer, and a first insulating layer stacked on the metal layer and disposed closer to the outer surface than the metal layer,
the sheet member extends from the first surface to the second surface through the third surface,
a first end portion on the first surface of the sheet member and a second end portion on the second surface of the sheet member are located outside inner edges of the first resin layer and the spacer and inside an outer edge of the current collector when seen in the stacking direction,
a first insulating member is provided from the first surface to the sheet member to cover the first end portion and is adhered to the first surface and the sheet member, and
a second insulating member is provided from the second surface to the sheet member to cover the second end portion and is adhered to the second surface and the sheet member.

2. The electric power storage module according to claim 1, wherein each of the first insulating member and the second insulating member is an insulating sheet including an adhesive layer adhered to each of the first surface and the second surface.

3. The electric power storage module according to claim 2, wherein the insulating sheet includes a welding layer thermally welded to each of the first surface and the second surface as the adhesive layer.

4. The electric power storage module according to claim 3, wherein the welding layer is further thermally welded to the sheet member.

5. The electric power storage module according to claim 1, wherein each of the first insulating member and the second insulating member includes a resin material hardened between the first surface and the second surface.

6. The electric power storage module according to claim 1, wherein each of the first insulating member and the second insulating member is adhered to each of the first surface and the second surface as well as the sheet member with an adhesive tape.

7. The electric power storage module according to claim 1, wherein each of the first insulating member and the second insulating member extends to reach the exposed portion of the current collector.
